(19) United States
(12) Patent Application Publication
(10) Pub. No.: US 2013/0177838 A1
(43) Pub. Date: Jul. 11, 2013

(54) HOLLOW NANOPARTICLES AS ACTIVE AND DURABLE CATALYSTS AND METHODS FOR MANUFACTURING THE SAME

(71) Applicants: Jia Xu Wang, East Setauket, NY (US); Radoslav R. Adzic, East Setauket, NY (US)

(72) Inventors: Jia Xu Wang, East Setauket, NY (US); Radoslav R. Adzic, East Setauket, NY (US)

(73) Assignee: Brookhaven Science Associates, LLC, Upton, NY (US)

(21) Appl. No.: 13/809,987

(22) PCT Filed: Jul. 13, 2011
(86) PCT No.: PCT/US11/43901

§ 371 Date: Mar. 28, 2013

Related U.S. Application Data
(60) Provisional application No. 61/364,040, filed on Jul. 14, 2010.

(51) Int. Cl. B01J 23/52; H01M 4/88; H01M 4/90; H01M 4/92; B01J 23/44; B01J 23/42

(52) U.S. Cl. CPC B01J 23/52; B01J 23/44; B01J 23/42; H01M 4/9041; H01M 4/92; H01M 4/8828
USPC 429/524; 502/330; 502/300; 502/339; 502/325; 502/5; 502/101; 429/525; 429/526; 427/115

(57) ABSTRACT

Hollow metal nanoparticles and methods for their manufacture are disclosed. In one embodiment the metal nanoparticles have a continuous and nonporous shell with a hollow core which induces surface smoothening and lattice contraction of the shell. In a particular embodiment, the hollow nanoparticles have an external diameter of less than 20 nm, a wall thickness of between 1 nm and 3 nm or, alternatively, a wall thickness of between 4 and 12 atomic layers. In another embodiment, the hollow nanoparticles are fabricated by a process in which a sacrificial core is coated with an ultrathin shell layer that encapsulates the entire core. Removal of the core produces contraction of the shell about the hollow interior. In a particular embodiment the shell is formed by galvanic displacement of core surface atoms while remaining core removal is accomplished by dissolution in acid solution or in an electrolyte during potential cycling between upper and lower applied potentials.

CROSS-REFERENCE TO A RELATED APPLICATION

This application claims the benefit under 35 U.S.C. 119(e) of U.S. Provisional Application No. 61/364,040 filed on Jul. 14, 2010, the content of which is incorporated herein in its entirety.

### STATEMENT OF GOVERNMENT RIGHTS

The present invention was made with government support under contract number DE ACO2-98CH10886 awarded by the U.S. Department of Energy. The United States government has certain rights in the invention.

### BACKGROUND

I. FIELD OF THE INVENTION

This invention relates generally to hollow nanoparticles and methods for their manufacture. In particular, the present invention relates to nanometer-scale particles having a continuous and nonporous shell with a hollow core which are produced by ultrathin film growth on nano-sized cores followed by selective removal of the core material. The invention also relates to the incorporation of such hollow nanoparticles in energy conversion devices.

II. BACKGROUND OF THE RELATED ART

Metals such as platinum (Pt), palladium (Pd), ruthenium (Ru), and related alloys are known to be excellent catalysts. When incorporated in electrodes of an electrochemical device such as a fuel cell, these materials function as electrocatalysts since they accelerate electrochemical reactions at electrode surfaces yet are not themselves consumed by the overall reaction. Although noble metals have been shown to be some of the best electrocatalysts, their successful implementation in commercially available energy conversion devices is hindered by their high cost and scarcity in combination with other factors such as a susceptibility to carbon monoxide (CO) poisoning, poor stability under cyclic loading, and the relatively slow kinetics of the oxidation reduction reaction (ORR).

A variety of approaches has been employed in attempting to address these issues. One well-known approach involves increasing the overall surface area available for reaction by forming metal particles with nanometer-scale dimensions. Loading of more expensive noble metals such as Pt has been further reduced by forming nanoparticles from alloys comprised of Pt and a low-cost component. Still further improvements have been attained by forming core-shell nanoparticles in which a core particle is coated with a shell of a different material which functions as the electrocatalyst. The core is usually a low-cost material which is easily fabricated whereas the shell comprises a more catalytically active noble metal. An example is provided by U.S. Pat. No. 6,670,301 to Adzic, et al. which discloses a process for depositing a thin film of Pt on dispersed Ru nanoparticles supported by carbon (C) substrates. Another example is U.S. Pat. No. 7,691,780 to Adzic, et al. which discloses platinum- and platinum alloy-coated palladium and palladium alloy nanoparticles. Each of the aforementioned U.S. Patents is incorporated by reference in its entirety as if fully set forth in this specification.

One approach for synthesizing core-shell particles with reduced noble metal loading and enhanced activity levels involves the use of electrochemical routes which provide atomic-level control over the formation of uniform and conformal ultrathin coatings of the desired material on a large number of three-dimensional nanoparticles. One such method involves the initial deposition of an atomic monolayer of a metal such as copper (Cu) onto a plurality of nanoparticles by underpotential deposition (UPD). This is followed by galvanic displacement of the underlying Cu atoms by a more noble metal such as Pt as disclosed, for example, in U.S. Pat. No. 7,704,918 to Adzic, et al. Another method involves hydrogen adsorption-induced deposition of a monolayer of metal atoms on noble metal particles as described, for example, by U.S. Pat. No. 7,507,495 to Wang, et al. Each of the aforementioned U.S. Patents is incorporated by reference in its entirety as if fully set forth in this specification.

Although each of these approaches has been successful in providing catalysts with a higher catalytic activity and reduced noble metal loading, still further improvements in both the durability and mass-specific catalytic activity are needed for electrochemical energy conversion devices to become reliable and cost-effective alternatives to conventional fossil fuel-based devices. One issue relating to the use of core-shell particles having a core comprised of one or more non-noble metals involves the gradual dissolution of the non-noble metal component over time. Exposure of the core to the corrosive environment typically present in energy conversion devices such as a proton exchange membrane fuel cell (PEMFC) due to, for example, an incomplete protective shell layer results in the gradual erosion of the non-noble metal components. With continued operation, this tends to reduce the catalytic activity of the electrocatalyst and cause damage to the electrolyte membranes contained within a typical energy conversion device, thereby reducing its charge storage and energy conversion capabilities.

There is therefore a continuing need to develop catalysts with a still higher catalytic activity in combination with ever-lower loading of precious metals, enhanced durability, and long-term stability. Such catalysts should also be capable of being manufactured by large-scale and cost-effective processes suitable for commercial production and incorporation in conventional energy production devices.

SUMMARY

In view of the above-described problems, needs, and goals, the inventors have devised embodiments of the present invention in which hollow nanoparticles and methods for their manufacture are provided. In one embodiment the hollow nanoparticles have nano-sized external dimensions and are characterized by a continuous and nonporous shell with a hollow core. In a particular embodiment the structure of the hollow core is such that it induces lattice contraction in the shell. In another embodiment the hollow nanoparticles are manufactured by a method which, in its most basic form, involves the initial formation of a plurality of nanoparticle cores followed by the deposition of a thin shell layer over the outer surface of the nanoparticle cores and the subsequent removal of the cores to produce hollow nanoparticles. The manufacturing process is simple and cost-effective, providing hollow nanoparticles with still higher catalytic activities and improved durability in combination with minimal loading of precious materials compared to catalysts currently in use.

In one embodiment, the nanoparticle cores are comprised of a single non-noble transition metal, but may comprise a plurality of elements or components. When more than one transition metal is used, the nanoparticle alloy is preferably a homogeneous solid solution, but it may also have compositional nonuniformities. The non-noble transition metal is preferably at least one of nickel (Ni), cobalt (Co), iron (Fe), copper (Cu), and/or their alloys. The nanoparticle cores provide a sacrificial template that acts as a reducing agent for deposition of one or a plurality of more noble metals on core surfaces and also provides a temporal core for forming the metal shells.

In one embodiment, the material constituting the shell layer is a noble metal, and in another embodiment the shell is a noble metal alloyed with one or more transition metals, including other noble metals. The composition of the shell is preferably homogeneous, but may also be nonuniform. The noble metal shell is preferably comprised of at least one of palladium (Pd), iridium (Ir), rhenium (Re), ruthenium (Ru), rhodium (Rh), osmium (Os), gold (Au), and platinum (Pt), either alone or as an alloy. In an especially preferred embodiment the shell is comprised of Pt. In yet another embodiment the shell is comprised of Pd or a PdAu alloy.

Removal of the core material from within the core-shell nanoparticles to leave behind only the material constituting the shell produces hollow nanoparticles having a continuous and nonporous external surface with a hollow core. In one embodiment the hollow nanoparticles are substantially spherical with an external diameter of less than 20 nm and a wall thickness of between 1 and 3 nm or, alternatively, a wall thickness of 4 to 12 atomic layers. In a more preferred embodiment, the external diameter of the hollow nanoparticles is between 3 nm and 9 nm with a wall thickness of 4 to 8 atomic layers. In an even more preferred embodiment the hollow nanoparticles have an external diameter of 6 nm and a wall thickness of 4 atomic layers. The hollow nanoparticles are preferably made of Pt, but in alternative embodiments may be made of Pd or a PdAu alloy. In yet another embodiment the hollow nanoparticles are made of Pd or a PdAu alloy which is covered with one or two monolayers of Pt.

In one embodiment the nanoparticle cores are formed on carbon supports by a process which involves forming a thin film of a carbon powder on an electrode, preparing a pH-buffered solution containing a salt of a metal, immersing the electrode in the pH-buffered solution, applying a first potential pulse to reduce the metal and nucleate metal nanoparticles on surfaces of the carbon powder, and applying a second potential pulse to increase the size of the nucleated metal nanoparticles. Since the density of nanoparticles is largely determined by the initial nucleation rate that increases with making the potential more negative, the first potential is typically used to control the density of nanoparticles and is often much lower than an equilibrium potential of the metal or the onset deposition potential for the metal ions in the solution. Reducing the deposition rate after less than one second at the first potential by applying a second potential that is higher than the first potential and lower than the equilibrium potential minimizes the diffusion-limiting effect that causes uneven particle size. The duration of the second potential typically determines the average size of the nanoparticles.

In one embodiment the solution may comprise 0.1 M to 0.5 M NiSO₄ or CoSO₄ and 0.5 M H₃BO₃ while the first potential is between −1.6 V and −1.0 V and the second potential is between −0.9 V and −0.7 V versus a Ag/AgCl (3 M NaCl) reference electrode. In yet another embodiment the first potential is the same as the second potential and both potentials are lower than the equilibrium potential of the metal. In still another embodiment, hollow nanoparticles may be formed by a method comprising producing a plurality of nanoparticles of a first metal by pulse potential deposition in a solution comprising a salt of the first metal, forming a shell layer of a second metal, which is more noble than the first metal, on an external surface of the nanoparticles to form core-shell nanoparticles, and removing the material constituting the first metal to produce a hollow nanoparticle comprised of the second metal. In an aspect of this embodiment the shell layer is formed by transferring the nanoparticles to and immersing the nanoparticles in a solution comprising a salt of the second metal in the absence of oxygen. In another aspect, the first metal is removed by immersing the core-shell nanoparticles in an electrolyte and repeatedly cycling an electrical potential applied to the core-shell nanoparticles between a lower and an upper limit.

The first metal solution may, for example, comprise a soluble salt of Ni and 0.5 M H₃BO₃. The soluble salt of Ni may be, for example, 0.1 M to 0.5 M NiSO₄. In another embodiment the salt of the second metal solution comprises 0.05 mM to 5 mM K₂PtCl₄ and is used in combination with a Ni salt to form Ni—Pt core-shell nanoparticles. Removal of the Ni core material in Ni—Pt core-shell nanoparticles may be accomplished by immersion in an acidic solution and cycling the applied electrical potential between 0.05 V and 1.2 V versus a reversible hydrogen electrode. In another embodiment the salt of the second metal comprises 0.05 mM to 5 mM of Pd(NH₃)₄Cl₂ and is used in combination with a Ni salt to form Ni—Pd core-shell nanoparticles. Removal of the Ni core in Ni—Pd core-shell nanoparticles may be accomplished by immersion in an acidic solution and cycling the applied electrical potential between 0.05 V and 1.0 V versus a reversible hydrogen electrode. In yet another embodiment, the salt of the second metal comprises 0.5 mM Pd(NH₃)₄Cl₂ and 0.025 mM HAuCl₃ and is used in combination with a Ni salt to form Ni—PdAu core-shell nanoparticles. Removal of the Ni core in Ni—PdAu core-shell nanoparticles may be accomplished by immersion in an acidic solution and cycling the applied electrical potential between 0.05 V and 1.1 V versus a reversible hydrogen electrode.

In another embodiment hollow nanoparticles may be formed by a method comprising producing a plurality of nanoparticles of a first metal by adding a chemical reducing agent to a slurry comprising a salt of the first metal and a carbon powder, forming a shell layer of a second metal which is more noble than the first metal on an external surface of said nanoparticles to form core-shell nanoparticles, and removing the material constituting the first metal to produce hollow nanoparticles comprised of the second metal by an acid treatment. The chemical reducing agent may be NaBH₄ or N₂H₄ with NaOH or Na₂CO₃ being used to adjust the solution pH. In the absence of oxygen, a solution comprising a salt of the second metal may be added into the slurry of the thus-formed core metal nanoparticles to form a thin shell layer of the second metal on the core of the first metal. One type of acid treatment involves removing the remaining first metal by sequentially adding an acid to lower the pH to 3 and then to lower the pH still further to a pH of 2 or 1 in order to completely remove the first metal.

In one embodiment hollow nanoparticles may be formed by initially mixing a solution comprising 10 mg carbon powder, 3 ml H₂O, and 1 ml 0.1 M NiSO₄ or NiCl₂. This solution is preferably sonicated and deaerated before the chemical reducing agent is added. When the chemical reducing agent is added, it is accompanied by vigorous stirring in a deaerated environment at room temperature. When using NiSO₄ or NiCl₂ in the solution, Ni nanoparticles dispersed on carbon powders may be formed. It is preferable that an excess of Ni ions be present in solution to ensure that the chemical reducing agent is fully consumed. In one embodiment the second metal which forms the shell of the core-shell nanoparticle is a noble metal, and in an even more preferred embodiment is Pt. In another embodiment the first metal may be removed by sequentially immersing the thus-formed core-shell particles in sonicated acid solutions having a pH which decreases down to a value of 3 and then to a value of 2 or 1.

Hollow nanoparticles are particularly advantageous when incorporated into one or more electrodes of an energy conversion device. The structure of such a device comprises at least a first electrode, a conducting electrolyte, and a second electrode, wherein at least one of the first or second electrodes comprises metal nanoparticles consisting of a continuous and nonporous shell with a hollow core, and wherein the hollow core has a structure that induces lattice contraction of the shell. In a preferred embodiment, the hollow nanoparticles incorporated into an energy conversion device are comprised of Pt and have an external diameter of 3 nm to 9 nm with a wall thickness of 4 to 8 atomic layers.

The production of hollow nanoparticles therefore permits a reduction in loading of precious materials while simultaneously maximizing the available catalytically active surface area and improving stability. The use of hollow nanoparticles as electrocatalysts facilitates more efficient, durable, and cost-effective electrochemical energy conversion in devices such as fuel cells and metal-air batteries. The use of Pt-based hollow nanoparticles may also provide similar advantages when used as a catalyst for oxidation of small organic molecules such as methanol and ethanol, where weakening Pt reactivity can enhance the catalyst's tolerance to poisoning intermediates or for hydrogenation reactions in producing renewable fuels.

### BRIEF DESCRIPTION OF THE DRAWINGS

FIG. 1 is a flowchart showing the sequence of steps followed in an exemplary method of forming hollow nanoparticles according to the present invention.

FIG. 2 shows cross-sectional illustrations of, from left to right, an as-prepared core nanoparticle of material M1, a core-shell nanoparticle with a shell of material M2, and a hollow nanoparticle formed by removal of the core material M1.

FIG. 3 shows a basic three-electrode electrochemical cell.

FIG. 4A is a transmission electron microscopy (TEM) image showing the atomic structure of Ni nanoparticle cores which serve as templates according to an embodiment of the invention.

FIG. 4B is a TEM image of Ni—Pt core-shell nanoparticles formed after galvanic replacement according to an embodiment of the invention.

FIG. 4C shows a TEM image of hollow Pt nanoparticles formed after potential cycling between an upper and a lower limit according to an embodiment of the invention.

FIG. 4D is a high-resolution scanning transmission electron microscopy (HR-STEM) image of a hollow Pt nanoparticle.

FIG. 4E is a line scan of the intensity profile nearly parallel to the lattice plane direction of the hollow Pt nanoparticle in FIG. 4D.

FIG. 4F is another HR-STEM image of a hollow Pt nanoparticle.

FIG. 4G is a line scan of the intensity profile nearly perpendicular to the lattice plane direction of the hollow Pt nanoparticle in FIG. 4F.

FIG. 4H is a model illustrating the z-thickness as a function of distance x along the y=0 center of an exemplary hollow nanoparticle.

FIG. 5A is a plot showing the oxidation reduction reaction (ORR) activities of platinum (Pt) hollow nanoparticles (average particle size=6.5 nm) and solid Pt nanoparticles (average particle size=3.2 nm); the ORR polarization and voltammetry (inset) curves were obtained in oxygen-saturated and deaerated 0.1 M HClO₄ solutions, respectively.

FIG. 5B is a bar graph comparing the electrochemical surface area (ESA), ORR-specific activity, and mass-specific activity of solid Pt nanoparticles and Pt hollow nanoparticles which were measured at 0.9 V with 10 mVs⁻¹ positive potential sweeps.

FIG. 6A is a plot showing the stabilized ORR activity of Pt hollow nanoparticles obtained before (right curve) and after (left curves) 3,000 and 6,000 pulse potential cycles between 0.65 V and 1.05 V; voltammetry curves for these same samples are provided in the inset.

FIG. 6B is a bar graph comparing the Pt mass activity for Pt nanoparticles and Pt hollow nanoparticles after continuous pulse potential cycling between 0.65 V and 1.05 V for 0, 50, and 100 hours.

FIG. 7A is a plot showing the ESA per unit Pt mass (left axis) and the ratio of high-coordinated atoms (N_{h-c}) to the total number of surface atoms (Nₛ), N_{h-c}/Nₛ (right axis), as a function of the particle size calculated using an icosahedral cluster (inset) as a near-sphere model.

FIG. 7B is a plot showing the ORR-active ESA, calculated by multiplying the ESA with N_{h-c}/Nₛ, as a function of the particle size.

FIG. 7C shows a TEM image of a plurality of Pt hollow nanoparticles with a selected-area electron diffraction pattern (SAED) obtained over the imaged nanoparticles provided in the lower right inset.

FIG. 7D shows X-ray powder diffraction intensity profiles for solid and hollow Pt nanoparticle samples which were fitted with lattice constant a, particle diameter d, and microstrain ε.

FIG. 7E is a plot showing density-functional theory (DFT) calculated changes in the oxygen binding energy from that of −4.09 eV on Pt(111) versus the lattice contraction (%) for atoms on (111) terraces using solid and hollow (2 atomic layer-thick) Pt semi-sphere models.

FIG. 8A shows actual and calculated X-ray powder diffraction intensity profiles for solid Pt nanoparticles with the difference between the two curves provided at the bottom of the plot.

FIG. 8B shows actual and calculated X-ray powder diffraction intensity profiles for hollow Pt nanoparticles with the difference between the two curves provided at the bottom of the plot.

FIG. 9 is a schematic showing the principles of operation of a fuel cell in which at least one electrode may be comprised of hollow nanoparticles, according to an embodiment of the present invention.

### DETAILED DESCRIPTION OF THE INVENTION

In the interest of clarity, in describing the present invention, the following terms and acronyms are defined as provided below:

### Acronyms

ALD: Atomic Layer Deposition
CVD: Chemical Vapor Deposition
EELS: Electron Energy Loss Spectroscopy
ESA: Electrochemical Surface Area
DFT: Density Functional Theory
HR-STEM: High-Resolution Scanning Transmission Electron Microscopy
ICP: Inductively Coupled Plasma
MBE: Molecular Beam Epitaxy
NHE: Normal Hydrogen Electrode
ORR: Oxidation Reduction Reaction
PEMFC: Proton Exchange Membrane Fuel Cell
PLD: Pulsed Laser Deposition
STEM: Scanning Transmission Electron Microscopy
TEM: Transmission Electron Microscopy
UPD: Underpotential Deposition

### Definitions

Adatom: An atom located on the surface of an underlying substrate.
Adlayer: A layer of (atoms or molecules) adsorbed to the surface of a substrate.
Bilayer: Two consecutive layers (of atoms or molecules) which occupy available surface sites on each layer and coat substantially the entire exposed surface of the substrate.
Catalysis: A process by which the rate of a chemical reaction is increased by means of a substance (a catalyst) which is not itself consumed by the reaction.
Electrocatalysis: The process of catalyzing a half cell reaction at an electrode surface by means of a substance (an electrocatalyst) which is not itself consumed by the reaction.
Electrodeposition: Another term for electroplating.
Electroplating: The process of using an electrical current to reduce cations of a desired material from solution to coat a conductive substrate with a thin layer of the material.
Monolayer: A single layer of atoms or molecules that occupies available surface sites and covers substantially the entire exposed surface of a substrate.
Multilayer: More than one layer of atoms or molecules on the surface, with each layer being sequentially stacked on top of the preceding layer.
Nanoparticle: Any manufactured structure or particle with nanometer-scale dimensions, i.e., 1-100 nm, along at least one of three orthogonal axes.
Noble metal: Metals which are extremely stable and inert, being resistant to corrosion or oxidation. These generally include ruthenium (Ru), rhodium (Rh), palladium (Pd), silver (Ag), rhenium (Re), osmium (Os), iridium (Ir), platinum (Pt), and gold (Au). Noble metals are frequently used as a passivating layer.
Non-noble metal: A transition metal which is not a noble metal.
Redox reaction: A chemical reaction wherein an atom undergoes a change in oxidation number. This typically involves the loss of electrons by one entity accompanied by the gain of electrons by another entity.
Submonolayer: Surface atomic or molecular coverages which are less than a monolayer.
Transition metal: Any element in the d-block of the periodic table which includes groups 3 to 12.
Underpotential Deposition: A phenomenon involving the electrodeposition of a species at a potential which is positive to the equilibrium or Nernst potential for the reduction of the metal.

Previous approaches to producing catalyst particles with a higher catalytic activity and reduced loading of costly precious metals have typically involved the use of one or more components which are susceptible to corrosion in alkaline or acidic environments. Over time, the gradual loss of these elements and their subsequent buildup in other critical components present within the energy conversion device, e.g., an electrolyte membrane, reduces both the activity level of the catalyst particles and the overall efficiency of the device. As an example, core-shell particles typically comprise a non-noble metal core and a noble metal shell. Incomplete surface coverage by the shell layer leaves the non-noble core material exposed, thereby leading to the gradual dissolution of the core material. This may significantly diminish the durability and activity level of the catalyst particles, making them unsuitable for long-term use.

These and other problems are addressed by embodiments of the present invention in which hollow nanoparticles comprised entirely of a corrosion-resistant material exhibiting a heightened catalytic activity and improved durability have been developed. It is believed that the enhanced activity is attributable at least partly to geometric effects in which the presence of a hollow interior induces lattice contraction and surface smoothening of the nanoparticle. While not wishing to be bound by theory, theoretical analyses reveal that hollow-induced contraction weakens oxygen binding at nanoparticle surfaces which, in turn, reduces oxygen-induced lattice expansion and surface roughening.

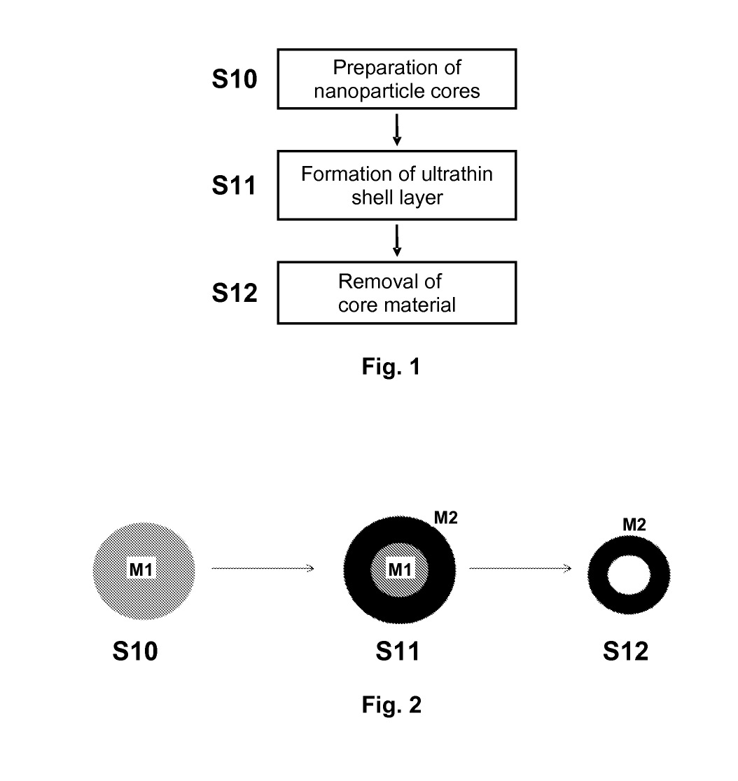

The overall process for forming hollow nanoparticles is described by the flowchart shown in FIG. 1 and schematic in FIG. 2. The process involves the initial production of nanoparticle cores of a first material M1 in step S10. This is followed by the formation of an ultrathin film of a second material M2 onto the surfaces of the nanoparticle cores in step S11. It is this second material M2 which will yield hollow nanoparticles upon removal of the core material M1. The final step S12 involves removal of the first material M1 such that only a hollow shell layer constituting the second material M2 remains.

The evolution of the structure of an exemplary nanoparticle core and shell layer is shown sequentially from left to right in FIG. 2. Although not shown in FIG. 2, in order to remove the core material it is implicit that there are gaps or holes in the shell's surface coverage which are of a size and quantity sufficient to permit removal of the core material. At the same time, the shell thickness in combination with the gap size and number of gaps per nanoparticle must be such that the shell layer is capable of maintaining its structural integrity once the core is removed. Furthermore, removal of the core material preferably proceeds in a manner that permits the shell layer to close over any and all gaps or holes present in the shell upon completion of the removal step to produce a hollow nanoparticle consisting of a continuous and nonporous shell which is completely enclosed about a hollow core.

The particular methods used to form the nanoparticle cores in step S10, the shell layer in step S11, and to remove the core material in step S12 are not limited to any particular process. Rather, each of the aforementioned steps may be accomplished using any of a plurality of processes which are well-known in the art. In order to facilitate a heightened catalytic activity, the processes used to form hollow nanoparticles preferably do not include the use of surfactants or other organic compounds. Surfactants have generally been used to control the particle size and to attain a higher particle yield. However, the inclusion of an organic material during particle synthesis significantly lowers the catalytic activity of the particles. Removal of the organic material requires the use of additional washing and/or heating processes which increase both the number of processing steps and the overall cost. Furthermore, even with the appropriate cleaning steps, a residual organic layer typically remains on the surfaces of the nanoparticles.

It is envisioned that one or more metals as well as semiconductors and mixtures or alloys of these may be used as the material constituting the core and/or shell material without deviating from the spirit and scope of the present invention. Throughout this specification, the hollow nanoparticles and processes for their manufacture will be described using one or more metals due to the advantages provided by their use as electrocatalysts and/or catalysts in general.

### I. Nanoparticle Core Synthesis

Initially nanoparticle cores of a suitable metal or metal alloy are prepared using any technique which is well-known in the art. It is to be understood, however, that the invention is not limited to metal nanoparticle cores and may include other materials which are well-known in the art including semiconductors. The nanoparticle cores may be comprised of a single element or material throughout or, in an alternate embodiment, the core may be a nanoparticle alloy. A nanoparticle alloy is defined as a particle formed from a complete solid solution of two or more elemental metals. However, such nanoparticle alloys are not limited to homogeneous solid solutions, but may also be inhomogeneous. That is, the nanoparticle alloy may not have an even concentration distribution of each element throughout the nanoparticle itself. There may be precipitated phases, immiscible solid solutions, concentration nonuniformities, and some degree of surface segregation.

The nanoparticle cores are preferably spherical or spheroidal with a size ranging from 2 nm to 100 nm along at least one of three orthogonal dimensions and are thus nanometer-scale particles or nanoparticles. It is to be understood, however, that the particles may take on any shape, size, or structure which includes, but is not limited to branching, conical, pyramidal, cubical, cylindrical, mesh, fiber, cuboctahedral, icosahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size is preferably configured to maximize surface catalytic activity. In a preferred embodiment the nanoparticle cores have external dimensions of less than 12 nm along at least one of three orthogonal directions. Throughout this specification, the particles will be primarily disclosed and described as nanoparticle cores which are substantially spherical in shape.

Solid nanoparticles, which are also known as nanocrystals or quantum dots, have been formed from a wide variety of materials using a number of different techniques which involve both top-down and bottom-up approaches. Examples of the former include standard photolithography techniques, dip-pen nanolithography, and focused ion-beam etching. The latter comprises techniques such as electrodeposition or electroplating onto templated substrates, laser ablation of a suitable target, vapor-liquid-solid growth of nanowires, and growth of surface nanostructures by thermal evaporation, sputtering, chemical vapor deposition (CVD), or molecular beam epitaxy (MBE) from suitable gas precursors and/or solid sources.

Solid nanoparticles may also be formed using conventional powder-processing techniques such as comminution, grinding, or chemical reactions. Examples of these processes include mechanical grinding in a ball mill, atomization of molten metal forced through an orifice at high velocity, centrifugal disintegration, sol-gel processing, and vaporization of a liquefied metal followed by supercooling in an inert gas stream. Nanoparticles synthesized by chemical routes may involve solution-phase growth in which, as an example, sodium boron hydride, superhydride, hydrazine, or citrates may be used to reduce an aqueous or nonaqueous solution comprising salts of a non-noble metal and/or noble metal. Alternatively, the salt mixtures may be reduced using H₂ gas at temperatures ranging from 150° C. to 1,000° C. These chemical reductive methods can be used, for example, to make nanoparticles of palladium (Pd), gold (Au), rhodium (Rh), iridium (Ir), ruthenium (Ru), osmium (Os), rhenium (Re), nickel (Ni), cobalt (Co), iron (Fe), copper (Cu), and combinations thereof. Powder-processing techniques are advantageous in that they are generally capable of producing large quantities of nanometer-scale particles with desired size distributions.

In one embodiment, nanoparticle cores may be formed on a suitable support material by pulse electrodeposition. This method involves initially preparing a thin film of a carbon powder on a glassy carbon electrode. Prior approaches have typically used a thin layer of Nafion, a polymer membrane, to affix the carbon powder onto the glassy carbon electrode. However, in this embodiment Nafion is not needed since a thin film of carbon powder is formed directly onto the glassy carbon electrode. A pH-buffered solution containing a salt of the metal to be reduced is then produced and the carbon-coated electrode is immersed in the solution. Reduction of the metal itself is accomplished by applying a first potential pulse to reduce the metal ions from solution and nucleate metal nanoparticles on the surfaces of the carbon powder support. This is followed by a second potential pulse whose duration is used to control the final size of the thus-formed nanoparticles.

The first potential pulse is thus used to control the nucleation rate whereas the second potential pulse is used to drive subsequent growth of the nucleated nanoparticles. By using two separate potential pulses, both the number density and the size of nanoparticle cores produced can be independently controlled by the duration of the pulses at the two potentials. In one embodiment, the first potential may range from −0.5 V to −0.2 V while the second potential may range from −0.3 V to −0.1 V. In another embodiment the first potential may range from −1.6 V to −1.0 V whereas the second potential ranges from −0.9 V to −0.7 V. All potential pulses are measured versus a Ag/AgCl (3 M NaCl) reference electrode.

When forming nanoparticle cores from a solution containing noble metal ions, the pH of the solution is preferably less than 2. A suitable noble metal solution for producing Pt nanoparticle cores may comprise, for example, 10 mM K₂PtCl₄ and 0.5 M H₂SO₄. Pulse potential deposition of Pt nanoparticle cores may then proceed by applying a first potential pulse in the range of −0.5 V to −0.2 V followed by a second potential pulse in the range of −0.5 V to −0.1 V. All potentials are measured using a Ag/AgCl (3 M NaCl) reference electrode. The pulse durations may be adjusted to attain the desired density and size distribution.

When forming nanoparticle cores from a solution containing non-noble metal ions, the pH of the solution is preferably higher than 4 so that the metal nanoparticles formed after potential pulse deposition will be stable. A suitable non-noble metal solution to produce Ni or Co nanoparticle cores may comprise 0.1 M to 0.5 M NiSO₄ or CoSO₄, respectively, with 0.5 M H₃BO₃. It is conceivable that other soluble salts of Ni may also be used. Pulse potential deposition of Ni or Co nanoparticle cores may then proceed by applying a first potential pulse in the range of −1.6 V to −1.0 V followed by a second potential pulse in the range of −0.9 V to −0.7 V. All potentials are measured versus a Ag/AgCl (3 M NaCl) reference electrode with the pulse duration being adjusted to obtain the desired density and size distribution.

In another embodiment nanoparticle cores may be formed by adding a chemical reducing agent to a solution comprising a salt of the desired metal. A typical reducing agent is NaBH₄ or N₂H₄ with NaOH or Na₂CO₃ being added as necessary to adjust the solution pH. An exemplary solution which may be used to form Ni nanoparticle cores on a carbon support comprises 10 mg carbon powder, 3 ml H₂O, and 1 ml 0.1 M NiSO₄ or NiCl₂. Prior to adding the reducing agent to reduce the Ni nanoparticles, the solution is preferably sonicated and deaerated. The reduction process proceeds by adding a small amount of the reducing agent to the slurry while vigorously stirring the solution in a deaerated environment at room temperature to produce Ni nanoparticles dispersed on a carbon powder support. In a particular embodiment, an excess of Ni ions is contained in solution to ensure that the reducing agent that is added to the solution is fully consumed.

By using a small amount of a strong reducing agent to control the particle size, the need for a surfactant is eliminated. Furthermore, the process mimics pulse potential deposition as described above since the reaction initially occurs very rapidly and then is abruptly terminated once the reducing agent has been fully consumed. Besides avoiding the use of a surfactant, consumption of all of the reducing agent allows subsequent processes to be performed in the same solution. For example, a salt of a different metal may be added to the reactor without needing to first filter out the thus-formed nanoparticle cores and create a new solution. This is particularly advantageous when forming a shell layer by galvanic displacement since a salt of a noble metal can be added directly to the solution as described in Section II below.

In yet another embodiment, nanoparticle cores may be formed by heating a dry mixture of carbon and adsorbed first metal ions in hydrogen. The carbon may be in powder or nanotube form and may be functionalized by immersing in HNO₃ and H₂SO₄ mixed acids, resulting in anion groups, such as, —CO₂H and —SO₃H, being attached at carbon surface. The exemplary dry mixture of carbon and the first metal ions is formed by stirring a slurry comprising a salt of first metal and functionalized carbon powder or carbon nanotubes for more than 10 hours, and then, filtering out the aqueous solution. After being dried at room temperature, the mixture is heated to about 700° C. in hydrogen for about 2 hours yielding nanoparticles of the first metal on carbon support. Before proceeding with the subsequent steps in the hollow nanoparticle production, the carbon-supported nanoparticle core of the first metal is preferably cooled in liquid argon (Ar).

It is to be understood that the methods of forming the nanoparticles described above are merely exemplary. Any of a plurality of alternative methods which are well-known in the art and which are capable of forming nanoparticles with the desired shape, size, and composition may be employed. The key aspect is that the nanoparticles provide a removable template of a predetermined size onto which a shell layer can be deposited. In a particular embodiment, the size of the nanoparticle cores is adjusted to maximize the catalytic activity of the resulting hollow nanoparticles.

### II. Formation of a Metal Shell

Once nanoparticles having the desired shape, composition, and size distribution have been fabricated, the desired ultrathin shell layer may then be formed. The particular process used to form the shell layer is not intended to be limited to any particular process, but is generally intended to be such that it permits formation of ultrathin films having thicknesses in the submonolayer-to-multilayer thickness range. For purposes of this specification, a monolayer (ML) is formed when the surface of a substrate, e.g., a nanoparticle, is fully covered by a single, closely packed layer comprising adatoms of a second material which forms a chemical or physical bond with atoms at the surface of the substrate. The surface is considered fully covered when substantially all available surface sites are occupied by an adatom of the second material. Preferably, the surface is considered fully covered when more than 90% of all available surface sites are occupied by an adatom of the second material, while even more preferable when more than 95% of all available surface sites are occupied by an adatom of the second material. If the surface of the substrate is not completely covered by a single layer of the adsorbing material, then the surface coverage is considered to be submonolayer. However, if a second or subsequent layers of the adsorbant are deposited onto the first layer, then multilayer surface coverages, e.g., bilayer, trilayer, etc., result.

The process for forming a shell layer by galvanic displacement occurs when the nanoparticle cores are immersed into a solution comprising a salt of a more noble metal. Since the salt is more noble than the core material, an irreversible and spontaneous redox reaction in which core surface atoms are oxidized and replaced by the more noble ions contained in solution occurs. Since the intent is to form hollow nanoparticles, the loss of core material during the redox reaction does not pose an issue and is, in fact, a desirable result. The ratio of the outer and inner diameter of the thus-formed hollow nanoparticles can be controlled by varying the concentration of the more noble metal ions and the duration for which the cores are immersed in the more noble metal salt solution.

As an illustrative embodiment, nanoparticle cores of a non-noble metal such as Cu, Ni, or Fe may initially be produced using any of the techniques described in Section I. The use of galvanic displacement is, however, especially advantageous when combined with chemical synthesis routes for the production of nanoparticle cores. Galvanic displacement proceeds by introducing the nanoparticles to a solution comprising a salt of a more noble metal such as, for example, Pt, Pd, Ir, Ru, Os, Au, or Re, by immersion in a solution comprising one or more of K₂PtCl₄, PdCl₂, IrCl₃, RuCl₃, OsCl₃, HAuCl₃, or ReCl₃, respectively. Using a Ni core and a Pt salt as an example, the galvanic replacement of surface Ni atoms by Pt occurs via the reaction Ni+Pt²⁺→Ni²⁺+Pt to produce Ni−Pt core-shell nanoparticles. Replacement of Ni surface atoms by Pt produces a reduction in size of the Ni nanoparticle core as can be seen by comparing the nanoparticle cores shown in steps S10 and S11 in FIG. 2. The final thickness and surface coverage of the resulting noble metal shell layer can be controlled by varying process parameters such as the concentration of the noble metal salt and the duration of the immersion in solution. In practice, many Ni particles which are less than 3 nm in diameter disappeared after immersion in solution, suggesting that they were completely replaced by Pt, and that during the process the Pt atoms were deposited onto nearby large particles. This may have the effect of increasing the overall size distribution of the remaining Ni—Pt core-shell particles. The dissolution of smaller Ni cores is actually beneficial because it is generally undesirable to have Ni particles having sizes of less than 3 nm; these particles were inevitably formed during synthesis of the Ni cores without using surfactants. Furthermore, the shell layer formed via galvanic displacement is not limited to a single metal, but may be formed as an alloy having several constituents to form a binary, ternary, quaternary, or quinary alloy. This may be accomplished, for example, by including more than one noble metal salt in solution.

An important aspect of shell formation via galvanic displacement involves inhibiting oxidation of and/or removal of any oxide formed on the surfaces of the nanoparticle cores once they have been fabricated. The formation of a surface oxide layer significantly inhibits the galvanic displacement process by forming metal-oxygen bonds at nanoparticle core surfaces. Thus, transfer into a solution comprising a metal salt to facilitate galvanic displacement by a more noble metal is preferably done in the absence of oxygen.

In one embodiment, galvanic displacement is performed by immersing the nanoparticle cores in a solution comprising 0.05 mM to 5 mM K₂PtCl₄ to produce a Pt shell layer. In another embodiment a Pd shell layer may be formed by immersing the nanoparticle cores in a solution comprising 0.05 mM to 5 mM Pd(NH₃)₄Cl₂. In yet another embodiment a PdAu shell layer may be formed by immersing the particles cores in a solution comprising 0.5 mM Pd(NH₃)₄Cl₂ and 0.025 mM HAuCl₃. In yet another two embodiments a Ru and an Ir shell layers may be formed by immersing the particle cores in a solution comprising 1 mM RuCl₃ and IrCl₃, respectively. The duration of exposure in each of the above exemplary metal salts is set to obtain the desired thickness of the shell layer.

In a preferred embodiment, carbon-supported nanoparticle cores of a non-noble metal such as Ni or Co are formed using the chemical reduction, dry heat treatment under hydrogen, or pulse potential deposition processes described in Section I above. When pulse potential deposition is used, the nanoparticles are transferred to a solution comprising the desired noble metal salt in the absence of oxygen to inhibit the formation of a surface oxide layer. When forming non-noble metal nanoparticle cores using chemical reduction methods, the non-noble metal salt is present in excess such that the reduction reaction proceeds to completion and all of the reducing agent is consumed. This permits addition of the desired concentration of a noble metal salt directly to the solution, thereby avoiding the need to filter out and rinse the core nanoparticles formed by chemical reduction methods. This is advantageous because it prevents exposure of the nanoparticle cores to the ambient where a surface oxide may form.

### III. Core Removal

Once suitable core-shell particles comprising a suitable core material and the desired shell layer have been formed, the final step in forming hollow nanoparticles involves removal of the core material. In one embodiment partial removal of the nanoparticle cores occurs during the formation of the shell by galvanic displacement, while the remaining core can be removed by dissolution in an acid solution or in an electrolyte during potential cycling between upper and lower applied potentials. In another embodiment the removal of the nanoparticle cores occurs via selectively dissolving the core material in the appropriate solvent. This may be accomplished, for example, by immersion in one or more acid, e.g., H₂SO₄ or HClO₄, solutions having the appropriate concentration for a specific time period. In one embodiment core removal proceeds by sequentially immersing the core-shell nanoparticles in acidic solutions having concentrations which gradually increase. For example, the core-shell nanoparticles may be first immersed in an acidic solution having a pH of about 3 for a predetermined time period, and then in an acidic solution having a pH of about 2 for a specified time, and finally in an acidic solution having a pH of about 1 for a specific period of time. As an example, the Ni core may be removed from Ni—Pt core-shell nanoparticles by first sonicating in an acidic solution having a pH of about 3 for about 20 min and then sonicating in an acidic solution having a pH of about 2 or about 1 for a another 20 minutes. In another embodiment, the pH of the solution may be decreased by adding discrete amounts of an acid to gradually decrease the pH in specific intervals.

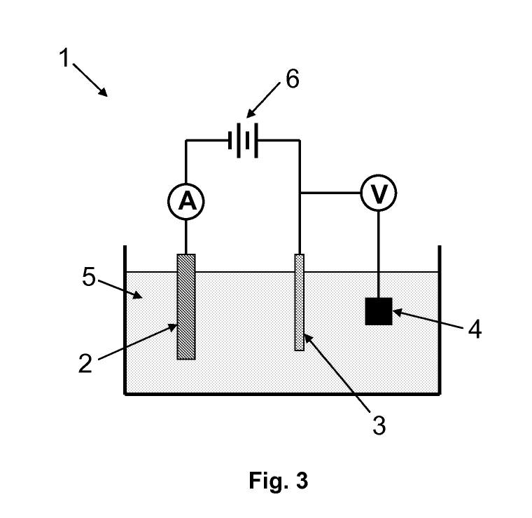

In another embodiment, dissolution of the core material may be accelerated by using an electrochemical cell to cycle an applied potential between an upper and lower limit. Using the three-electrode electrochemical cell (1) in FIG. 3 as an example, dissolution of the core may be accomplished with the core-shell nanoparticles provided on the working electrode (3). The electrochemical cell (1) shown in FIG. 3 is also provided with a counter electrode (2), a reference electrode (4), and an external power supply (6). The working electrode (3) is immersed in a suitable electrolyte (5) having the desired concentration and the potential applied to the working electrode (3) is cycled between an upper and a lower limit a predetermined number of times. The number of cycles used is preferably the minimum number sufficient to completely remove the core material. For example, the core of a core-shell nanoparticle having a Pt shell layer may be removed by potential cycling in an acidic solution between 0.05 V and 1.2 V versus a reversible hydrogen electrode. In another example, the core of a core-shell nanoparticle having a Pd shell layer may be removed by potential cycling in an acidic solution between 0.05 V and 1.1 V versus a reversible hydrogen electrode. As illustrated in FIG. 3, the electric current in the electrochemical cell (1) can be measured by an Ammeter ( [symbol] ), while the electrical potential in the electrochemical cell (1) can be measured by a Voltmeter ( [symbol] ).

An important consideration in core removal is that it is preferable that the dissolution process not only remove all core material, but also leave behind hollow nanoparticles with a complete shell layer. That is, it is preferable that the shell layer present about the hollow core close in on itself after removal of the core material, thereby forming a hollow nanoparticle which fully encapsulates the hollow interior. Although this structure is preferred, hollow nanostructures having one or more openings or gaps in the shell layer typically form during processing. However, it is believed that these structures generally are less stable than hollow nanoparticles having an enclosed shell layer. In some embodiments, the thus-formed hollow nanoparticles may have a small fraction of the core remaining within the hollow interior. This is increasingly likely when a large number of hollow nanoparticles are simultaneously produced as would be the case during commercial manufacturing operations. As long as the shell is enclosed and the remaining core material is smaller than the size of the hollow core, this should not have a measurable impact on performance.

As previously indicated, a significant advantage of the processes used for forming hollow nanoparticles described in Sections I, II, and III is that no organic solvents are used nor are they needed during processing. This is particularly beneficial when forming nanoparticles for use as electrocatalysts because the presence of organic components significantly reduces their catalytic activity. Another advantage is that the processes described in this specification can be readily adapted for large-scale, low-cost commercial manufacturing.

Hollow nanoparticles made of a catalytically active and corrosive-resistant material have been found to be ideal for use as electrocatalysts. They provide the advantages of minimal loading attainable when using conventional core-shell nanoparticles, but circumvent problems associated with core dissolution while producing and maintaining still-higher activity levels. Furthermore, the catalytic activity of the final coated particle may be controlled by engineering the relative sizes of the nanoparticle, the interior core, and, hence, the shell thickness. The high mass-specific activity and enhanced stability demonstrated by hollow nanoparticles may contribute to achieving the best overall performance for ORR electrocatalysts.

### IV. Exemplary Embodiments

The hollow nanoparticles fabricated using the processes described in this specification are preferably made of a noble metal, and in an even more preferred embodiment are made of Pt. In another embodiment the hollow nanoparticles may be made of Pd or a PdAu alloy. In yet another embodiment a hollow nanoparticle of Pd or a PdAu alloy is coated with one or two MLs of Pt. Deposition of Pt onto hollow Pd or PdAu nanoparticles may be accomplished, for example, by the galvanic displacement process described in Section II above.

The hollow nanoparticles preferably consist of a continuous, smooth, and nonporous surface shell with a hollow core contained therein. The hollow core itself has a structure which induces lattice contraction and surface smoothening of the shell. The hollow nanoparticles preferably have an external diameter of less than 20 nm with a shell thickness of 1 nm to 3 nm which is equivalent to 4 to 12 atomic layers. In a more preferred embodiment the hollow nanoparticles have an external diameter of 3 nm to 9 nm with a shell thickness of 4 to 8 atomic layers. In an even more preferred embodiment the hollow nanoparticles have an external diameter of 6 nm and a shell thickness of 4 atomic layers. The hollow nanoparticles preferably are single crystal, having a single lattice orientation across each nanoparticle. Compared to solid nanoparticles, the lattice contraction induced in hollow nanoparticles may make them more stable in acidic media and more active as a catalyst for desorption limited reactions.

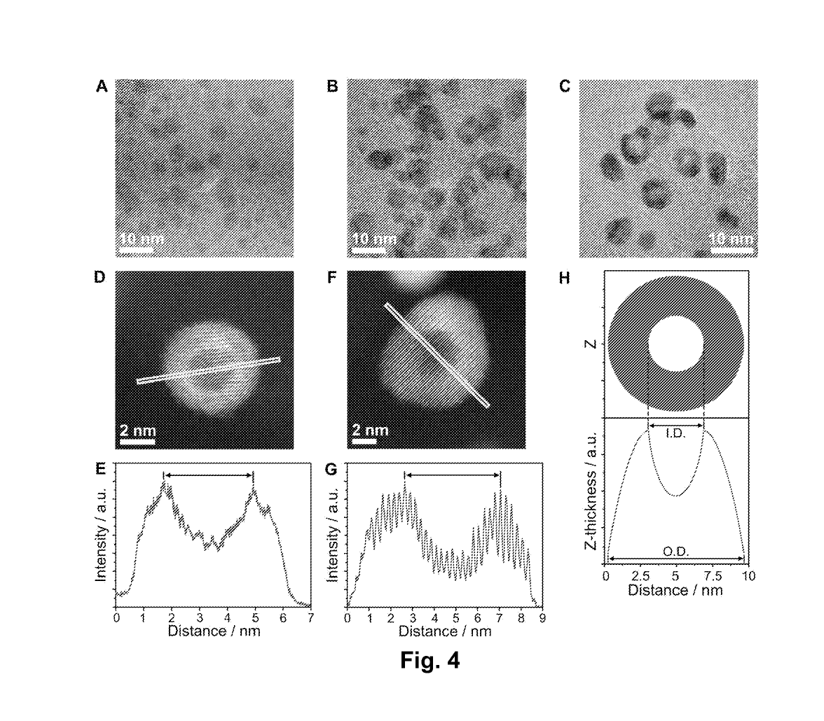

An exemplary embodiment of the present invention will be described in detail with reference to FIGS. 4-8. In this embodiment, Ni nanoparticles fabricated on carbon powder supports are used as the core material and Pt is used as the shell material. Initially, 10 mg of carbon powder (˜60 μg/cm² Vulcan 72, E-TEK) was dispersed in 13 ml H₂O by sonication in an ice-mixed ultrasonic bath. An amount equal to 15 μl of this uniform slurry was transferred to a glassy carbon rotating disk electrode having a diameter of 0.5 cm.

After drying in air, the carbon thin-film electrode was brought into an Argon (Ar)-saturated 0.1 M NiSO₄ and 0.5 M H₃BO₃ solution. The Ni nanoparticle cores were generated by applying a single potential pulse at −1.4 V (vs. Ag/AgCl, 3 M NaCl) for 0.4 s followed by 30 s at −0.8 V. The Ni nanoparticles were produced with 5 mC to 8 mC integrated charge. Within 5 minutes, the open-circuit potential rose to a stable value. The transmission electron microscopy (TEM) image provided in FIG. 4A shows that the thus-formed Ni nanoparticles were, on average, smaller than 9 nm in diameter.

Formation of a Pt shell layer was accomplished by transferring the rotating disk electrode into a deaerated K₂PtCl₄ solution in the same Ar-filled compartment. Pt ions in solution were reduced by metallic Ni via the reaction Ni+Pt²⁺→Ni²⁺+Pt with the amount controlled by the concentration of K₂PtCl₄ (0.1 mM to 1 mM) and the duration of galvanic replacement (3 to 30 minutes). After the electrode was immersed for a predetermined period of time, it was removed from solution and rotated in pure water to remove residual metal ions. A sample TEM image of Ni—Pt core-shell particles produced after 5 minutes in a deaerated 1 mM K₂PtCl₄ solution is provided in FIG. 4B. The TEM image reveals that many of the smaller nanoparticles (<3 nm) are no longer visible. The higher intensity present around the edges of the nanoparticles reflects Pt deposition on the Ni core.

Dissolution of the Ni core material was accomplished by transferring the electrode to a solution comprising 0.1 M HClO₄. Twenty potential cycles from 0.05 V to 1.2 V (vs. RHE) were applied to completely remove the Ni core and produce Pt hollow nanoparticles. A sample TEM image of the thus-formed Pt hollow nanoparticles is provided in FIG. 4C. No residual Ni was detected using either electron energy loss spectroscopy (EELS) or by inductively coupled plasma mass spectrometry (ICPMS). The weaker intensity at the center of the nanoparticles in FIG. 4C indicates the formation of Pt hollow nanoparticles.

High-resolution scanning TEM (HR-STEM) measurements performed on the samples after electrochemical measurements and durability tests were completed revealed the presence of compact hollow particles with a single lattice orientation across each particle. Examples are shown by the sample HR-STEM images provided in FIGS. 4D and 4F. The size of the hollow cores was determined by the distances between the positions of the intensity maxima provided in the line scans shown in FIGS. 4E and 4G because, as illustrated in FIG. 4H, the maxima in vertical thickness occur at the edges of a hollow. The average nanoparticle size was 6.5 nm while the largest hollow-to-particle size ratio observed in this embodiment was 5.6 nm/7.8 nm with a 1.1 nm shell thickness. In one embodiment, the structure of hollow nanoparticles optimized for the ORR comprises substantially spherical hollow particles which have an external diameter of 3 nm to 9 nm and a shell thickness of 1 nm to 2 nm which corresponds to approximately 4 to 8 atomic layers.

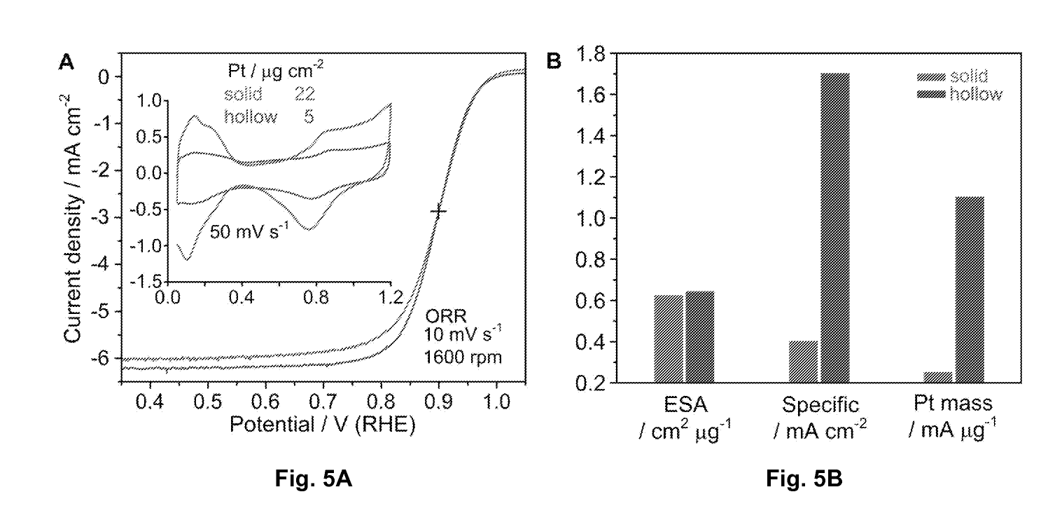

The ORR activity and durability of the Pt hollow nanoparticles were measured and compared to solid Pt nanoparticles having an average size of 3.2 nm. The results are provided in FIG. 5A which shows voltammetry and ORR polarization curves for Pt hollow and solid Pt nanoparticles after 20 potential cycles between 0.05 V and 1.2 V vs. RHE. Similar polarization curves with a well-defined limiting current at low potentials, j_{L}, were obtained for both nanoparticle types. Since the kinetic currents measured at 0.9 V, which were calculated using jₖ=j (1−j/j_{L}), are the same for both hollow and solid Pt nanoparticles while the Pt loading was reduced by a factor of 4.4 for hollow particles, there was therefore a 4.4-fold enhancement in Pt mass activity. The electrochemical surface area (ESA) was measured using the integrated hydrogen-desorption charges from the voltammetry curves, assuming 0.21 mC cm⁻², and the results are summarized in FIG. 5B. The bar graph provided in FIG. 5B shows that 6.5-nm average hollow particles have similar ESAs per unit Pt mass to 3.2-nm average solid particles. This means that the enhancement in Pt mass activity primarily results from the increased specific activity since it is obtained from the product of the ESA and the specific activity.

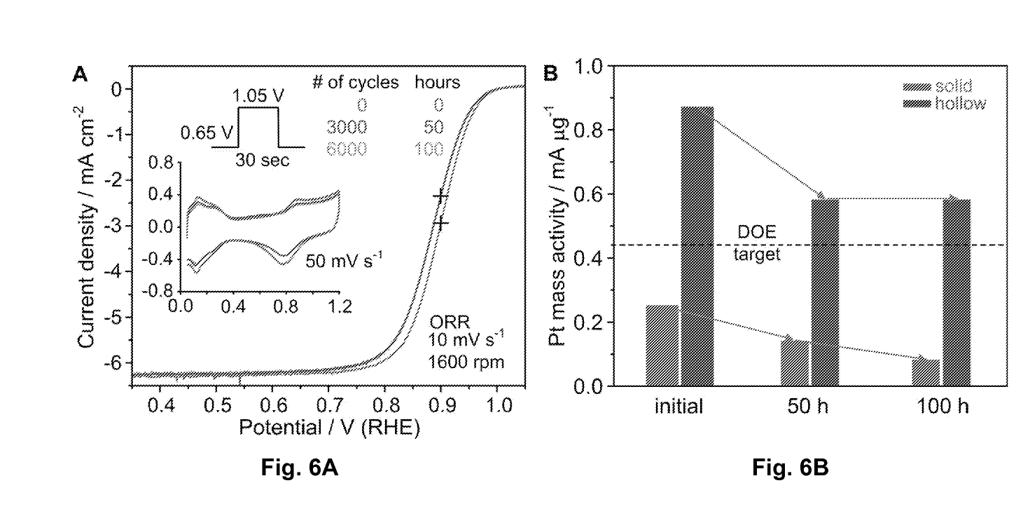

The durability of the Pt hollow nanoparticles was tested with potential cycles swept between 0.65 V and 1.05 V at scan rate of 50 mVs⁻¹. No loss in surface area or ORR activities was observed for Pt hollow spheres after 10,000 cycles. Potential cycles pulsed between 0.65 V and 1.05 V with a 30-second dwell time at each limit were used. Stepping between two limiting potentials with long dwell time is considered to be a severe test of stability because the dissolution of low-coordinate sites is most rapid at 0.65 V and defects are most likely regenerated above 1 V. This mechanism is based on the reported highest dissolution rate of Pt(111) steps at 0.65 V, and the 0.6-nm deep holes observed over the whole surface area at 1.15 V. The results of pulsed potential cycling are provided in FIG. 6A which shows that there is approximately a 33% loss in the ORR activity after 3,000 pulse potential cycles over 50 hours, but no further loss was observed thereafter.

TEM analyses show that the nonporous Pt hollow particles survived the durability tests. Fewer Pt hollow particles with visible holes were observed in TEM images after undergoing durability tests. Therefore, a small initial activity loss is correlated with the instability of particles having apparent holes or gaps in the shell layer. The sustainable Pt mass activity after prolonged pulse potential cycling was measured to be 0.58 mA·μg⁻¹, a value that exceeds the DOE target of 0.44 mA·μg⁻¹ for platinum group metals. In another durability test, no loss of stabilized activity was observed after an additional 7,000 cycles. For solid Pt nanoparticles (45% Pt/C, 3.2 nm average diameter), a commonly used benchmark, it was found that the ORR activity decreased substantially after 3,000 cycles and continued to fall during an additional 3,000 potential cycles. The results are summarized in the bar graph provided in FIG. 6B. As FIG. 6B shows, the stabilized Pt mass activity for Pt hollow spheres is increased 6-fold over that of solid Pt nanoparticles after 6,000-cycle, 100-hour durability tests. This finding is significant because previous results have shown that aged Pt-alloy nanoparticle catalysts maintained only a 2-fold enhanced activity over aged Pt nanoparticles in PEMFC tests.

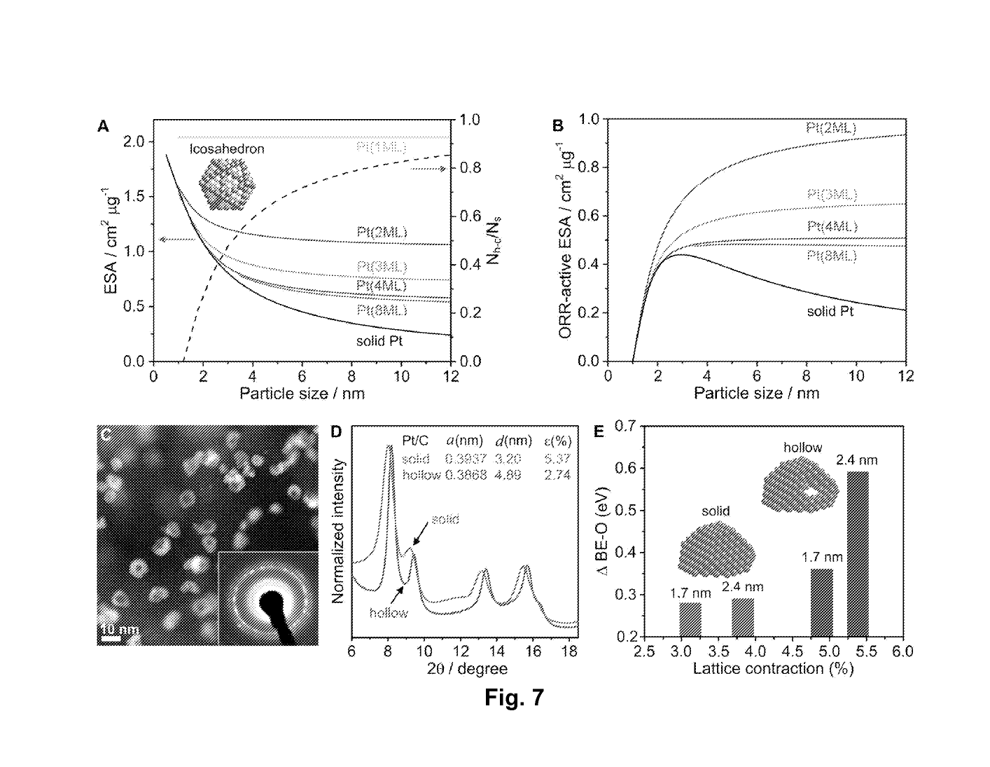

The enhanced ORR activity and durability observed for Pt hollow spheres is partly attributed to geometric effects which will be described with reference to FIGS. 7A and 7B. The ESA per unit Pt mass is 2.04 cm²·μg⁻¹, independent of the particle size for Pt monolayer catalysts, assuming a surface atomic density equal to that of the Pt(111) surface. Using an icosahedral cluster as the model for near-spherical particles, it was observed that the ESA per unit Pt mass decreases with increasing particle size. This is concomitant with an increase in the ratio of high-coordinated sites on terraces (N_{h-c}) to the total number of surface atoms (Nₛ), N_{h-c}/Nₛ.

Since the ORR rate is limited by O- and OH-desorption on Pt, less reactive high-coordinated (111) terraces are most conducive to the ORR. Thus, the product of ESA and N_{h-c}/Nₛ represents the ORR-active ESA. While the active ESA per Pt mass exhibits a maximum near 3 nm for solid Pt nanoparticles, it reaches a higher value in the 3- to 12-nm size range for hollow particles having a shell thickness of 4 to 8 atomic layers (see, e.g., FIG. 7B). This suggests that the optimized hollow particle size is around 6 nm, which is highly beneficial from a durability standpoint because the Pt dissolution rate increases sharply with decreasing size below 5 nm.

Aside from favorable geometric effects, the six-fold enhancement of durable Pt mass activity is also attributed primarily to hollow-induced lattice contraction and surface smoothing. FIG. 7C shows an example TEM image in which well-calibrated selected area electron diffraction (SAED) measurements reveal an average lattice constant of 0.3847 nm over the imaged Pt hollow particles. This corresponds to a lattice contraction relative to Pt bulk (α₀=0.3923 nm) of −2.0%. X-ray diffraction measurements were also performed on both solid and hollow Pt nanoparticles and the results are provided in FIG. 7D. A −1.4% lattice contraction was observed for Pt hollow particles made by using a chemically reduced Ni template with acid treatment whereas a 0.33% expansion was observed for solid Pt nanoparticles. Putting these results in perspective, it is noted that for solid metal nanoparticles, lattice contraction generally increases with decreasing particle size, especially for particle sizes of <5 nm. This has been previously demonstrated on Au, the most noble metal, and on Pt and Cu nanoparticles which were made and kept under vacuum. However, exposure to air causes surface oxidation of many metal nanoparticles, especially for those having sub-10-nm sizes. This induces lattice expansion which may cancel or overwhelm the nanoscale-induced lattice contraction.

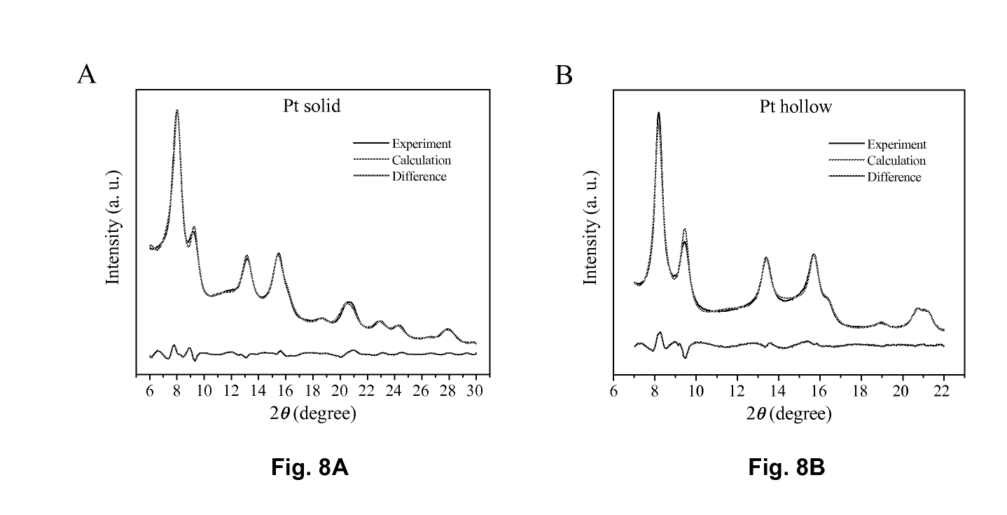

The amount of lattice expansion and microstrain induced by oxidation of solid and hollow Pt nanoparticles was measured by X-ray diffraction. Solid Pt nanoparticles were measured to have a 0.33% lattice expansion and 5.4% microstrain as determined by the X-ray diffraction peak positions and peak broadening, respectively (see, e.g., FIG. 8A). The latter reflects the degree of distortion from the average lattice spacing. These results indicate that surface oxidation, even with a very small amount on Pt, induces significant structural changes. In comparison, the X-ray diffraction results provided in FIG. 8B yielded a −1.4% lattice contraction and 50% reduction of microstrain for Pt hollow nanoparticles. These results suggest that hollow-induced contraction weakens surface oxidation which, in turn, reduces oxidation-induced lattice expansion and roughening at the surface.

The calculated surface contraction shown in FIG. 7E cannot directly describe the properties of the hollow particles in our samples due to the size and thickness gaps, as well as the absence of surface oxidation effects in the calculations. However, the trend is clear that lattice contraction, and thus, weakening of oxygen binding energy from that on Pt(111), is greater for hollow than for solid nanoparticles, independent of the particle size. The discovery of hollow-induced lattice contraction illustrates a new route for achieving required activity and durability of ORR nanocatalysts for PEMFC application in hydrogen vehicles.

Having a hollow core undoubtedly is beneficial from the standpoint of lowering costs and eliminating issues related to unstable core materials migrating into electrolyte membranes. In this exemplary embodiment, the use of chemical reducing agents to produce large quantities of Ni nanoparticle templates provides an inexpensive, surfactant-free, and environmental-friendly synthesis route. Galvanic displacement in a Pt salt followed by core dissolution through potential cycling in an acidic solution provides a simple yet robust means of synthesizing a large quantity of hollow Pt nanoparticles. The excellent catalytic activity and durability of hollow nanoparticles make them ideal candidates for next generation energy conversion devices.

### V. Energy Conversion Devices

In a preferred application, the hollow nanoparticles as described above may be used as an electrode in an energy conversion device such as a fuel cell. The use of hollow nanoparticles advantageously provides minimal loading of precious metals, a heightened catalytic activity, and improved durability. Use of hollow nanoparticles in a fuel cell is, however, merely exemplary and is being used to describe a possible implementation of the present invention. Implementation as a fuel cell electrode is described, for example, in U.S. Pat. No. 7,691,780 to Adzic. It is to be understood that there are many possible applications for hollow nanoparticles which may include, but are not limited to, charge storage devices, applications which involve corrosive processes, as well as various other types of electrochemical or catalytic devices.

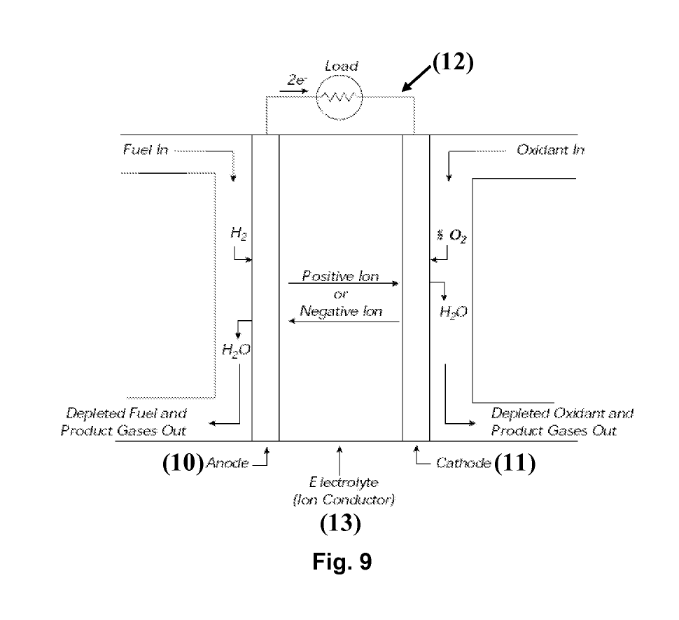

A schematic showing an example of a fuel cell and its operation is provided in FIG. 9. A fuel such as hydrogen gas (H₂) is introduced through a first electrode (10) whereas an oxidant such as oxygen (O₂) is introduced through the second electrode (11). In the configuration shown in FIG. 9, the first electrode (10) is the anode and the second electrode (11) is the cathode. At least one electrode preferably is comprised of hollow Pt nanoparticles. Under standard operating conditions electrons and ions are separated from the fuel at the anode (10) such that the electrons are transported through an external circuit (12) and the ions pass through an electrolyte (13). At the cathode (11) the electrons and ions combine with the oxidant to form a waste product which, in this case, is H₂O. The electrical current flowing through the external circuit (12) can be used as electrical energy to power conventional electronic devices.

The increase in the ORR attainable through incorporation of hollow nanoparticles in one or more electrodes will produce an increase in the overall energy conversion efficiency and durability of the fuel cell. Consequently, for a given quantity of fuel, a larger amount of electrical energy will be produced when using hollow nanoparticle electrodes compared to conventional nanoparticle electrodes. Furthermore, the increased durability provided by hollow nanoparticle electrodes means that fuel cells which incorporate such electrodes can be used for longer periods of time without a substantial drop in performance.

It will be appreciated by persons skilled in the art that the present invention is not limited to what has been particularly shown and described hereinabove. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. That alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are hereby incorporated by reference in their entireties as if fully set forth in this specification.

1. A catalyst particle comprising:
a metal nanoparticle consisting of a continuous and nonporous shell with a hollow core,
wherein the hollow core has a structure that induces lattice contraction of the shell and forms a smooth shell surface.

2. The catalyst particle of claim 1 wherein said hollow nanoparticle is less reactive than a solid nanoparticle of similar composition, size, and shape, making the hollow nanoparticle more stable in acidic media and more active as a catalyst for desorption-limited reactions.

3. The catalyst particle of claim 1 wherein the nanoparticle is substantially spherical, and the shell includes a shell wall with an interior and an exterior surface, an external diameter of the shell as measured between opposing exterior surfaces is less than 20 nm, and a wall thickness, as measured between the interior and exterior surface of the shell is between 1 nm and 3 nm.

4. The catalyst particle of claim 1 wherein the nanoparticle comprises at least one noble metal.

5. The catalyst particle of claim 4 wherein the nanoparticle comprises platinum (Pt).

6. The catalysts particle of claim 4 wherein the nanoparticle comprises palladium (Pd) or a palladium/gold (Pd/Au) alloy, ruthenium (Ru), or iridium (Ir).

7. The catalyst particle of claim 6 wherein the nanoparticle is covered with 1 to 12 monolayers of platinum (Pt).

8. The catalyst particle of claim 7 wherein the nanoparticle is covered with 4 to 12 monolayers of platinum (Pt).

9. A method of forming hollow nanoparticles comprising:
producing a plurality of nanoparticles of a first metal
by pulse potential deposition in a solution comprising a salt of the first metal
by adding a chemical reducing agent to a solution comprising a salt of the first metal, or
by heating a dry mixture of carbon and adsorbed first metal ions in hydrogen;
forming a shell layer of a second metal which is more noble than the first metal on an external surface of the nanoparticles to form core-shell nanoparticles; and
removing the material constituting the first metal to produce a hollow nanoparticle comprised of the second metal.

10. The method of claim 9 wherein the process of producing a plurality of nanoparticles of a first metal by pulse potential deposition comprises:
forming a thin film of a carbon powder on an electrode;
preparing a pH-buffered solution containing a salt of a metal;
immersing the electrode in the solution;
applying a first potential pulse to reduce the metal and nucleate metal nanoparticles on surfaces of the carbon powder; and
applying a second potential pulse to increase the size of the nucleated metal nanoparticles.

11. The method of claim 10 wherein the first potential is between −1.6 V and −1.0 V, the second potential is between −0.9 V and −0.7 V as measured against a Ag/AgCl (3 M NaCl) reference electrode, and the solution comprises 0.1 M to 0.5 M NiSO₄ or CoSO₄ and 0.5 M H₃BO₃.

12. The method of claim 9 wherein the shell layer is formed by transferring the nanoparticles to and immersing the nanoparticles in a solution comprising a salt of the second metal in the absence of oxygen.

13. The method of claim 12 wherein the salt of the second metal solution comprises 05 mM to 5 mM K₂PtCl₄.

14. The method of claim 9 wherein the first metal is removed by immersing the core-shell nanoparticles in an electrolyte and repeatedly cycling an electrical potential applied to the core-shell nanoparticles between a lower and an upper limit.

15. The method of claim 9 wherein the process of producing a plurality of nanoparticles of a first metal by adding a chemical reducing agent to a solution comprises:
combining the salt of the first metal, a carbon powder, and water to form a slurry;
sonicating and dearating the slurry to disperse the carbon powder in a first metal salt solution; and
adding the chemical reducing agent to the solution.

16. The method of claim 15 wherein the chemical reducing agent is NaBH₄ or N₂H₄ which is pH-adjusted by NaOH or Na₂CO₃ and added to the slurry with vigorous stirring in a deaerated environment to produce first metal nanoparticles dispersed on carbon powders.

17. The method of claim 15 wherein an excess of Ni ions is present in solution to ensure that the chemical reducing agent is fully consumed.

18. The method of claim 9 wherein the first metal is removed by immersing the core-shell nanoparticles in an acidic solution having a pH of about 3 and then immersing the core-shell nanoparticles in an acidic solution having a pH of about 2 or about 1.

19. The method of claim 15 wherein the noble-metal shell is formed by adding the solution comprising a salt of the noble metal into the slurry, and the first metal is removed by immersing the core-shell nanoparticles in an acidic solution having a pH of about 3 and then immersing the core-shell nanoparticles in an acidic solution having a pH of about 2 or about 1.

20. The method of claim 9 wherein the process of producing a plurality of nanoparticles of a first metal by heating a dry mixture of carbon and adsorbed first metal ions in hydrogen comprises:
combining a salt of first metal in aqueous solution and a functionalized carbon powder or carbon nanotubes to form a slurry;
stirring the slurry for more than 10 hours,
filtering the aqueous solution out of the slurry;
drying the slurry at room temperature to form the dry mixture of carbon and adsorbed first metal ions; and
heating the dry mixture to about 700° C. in hydrogen for about 2 hours to yield nanoparticles of the first metal on carbon support.

21. The method of claim 9 wherein the process of
producing a plurality of nanoparticles of a first metal by heating a dry mixture of carbon and adsorbed first metal ions in hydrogen comprises:
forming a shell layer of a second metal which is more noble than the first metal on an external surface of the nanoparticles by cooling the dry mixture, transferring the cooled mixture into a dearated solution comprising a salt of the second metal under inert gas atmosphere, and removing the material constituting the first metal to produce a hollow nanoparticle by lowering pH of the dearated solution to about 1.

22. The method of claim 20 further comprising
forming a shell layer of a second metal which is more noble than the first metal on an external surface of the nanoparticles by cooling the dry mixture, transferring the cooled mixture into a dearated solution comprising a salt of the second metal under inert gas atmosphere, and
removing the material constituting the first metal to produce a hollow nanoparticle by lowering pH of the dearated solution to about 1.

23. An energy conversion device comprising:
a first electrode;
a conducting electrolyte; and
a second electrode,
wherein at least one of the first or second electrodes comprises a plurality of catalyst particles of claim 1.

24. The energy conversion device of claim 23 wherein the nanoparticle comprises platinum (Pt) and the shell has an external diameter of 3 nm to 9 nm with a wall thickness of 4 to 8 atomic layers.
